(19) United States
(12) Patent Application Publication
(10) Pub. No.: US 2011/0239745 A1
(43) Pub. Date: Oct. 6, 2011

(54) Rapid Identification of Explosives Using Thin-Layer Chromatography and Colorimetric Techniques

(75) Inventors: Joe H. Satcher, JR., Patterson, CA (US); Philip F. Pagoria, Livermore, CA (US); Richard E. Whipple, Kaneohe, HI (US); M. Leslie Carman, San Ramon, CA (US)

(73) Assignee: Lawrence Livermore National Security, LLC, Livermore, CA (US)

(21) Appl. No.: 13/028,072

(22) Filed: Feb. 15, 2011

Related U.S. Application Data
(60) Provisional application No. 61/320,165, filed on Apr. 1, 2010.

(51) Int. Cl. G01N 30/02

(52) U.S. Cl. 73/61.55

(57) ABSTRACT

A thin-layer chromatography method for identifying material present in a sample on a location including the steps of provide a thin-layer chromatography plate, wetting a swab is with a solvent providing a wetted swab, contacted the location of interest is with the wetted swab to obtain the sample providing a wetted swab with sample, placing the wetted swab with sample in the solvent to dissolve the sample and provide a solvent with sample, dipping a micropipette into the solvent with sample to obtain an amount of the solvent with sample, spotting the amount of the solvent with sample on the thin-layer chromatography plate, allowed the amount of the solvent with sample on the thin-layer chromatography plate to dry providing a thin-layer chromatography plate with sample, placing the a thin-layer chromatography plate with sample into a developing chamber with solvent mixture, allowing the thin-layer chromatography plate with sample to develop producing a developed thin-layer chromatography plate with sample, removing the developed thin-layer chromatography plate with sample from the developing chamber, and illuminating the developed thin-layer chromatography plate with sample with ultra violet light to produce an image for identifying the material present in the sample.

### CROSS-REFERENCE TO RELATED APPLICATIONS

The present application claims benefit under 35 U.S.C. §119(e) of U.S. Provisional Patent Application No. 61/320,165 filed Apr. 1, 2010 entitled “Rapid identification of explosives using Thin-layer chromatography and colorimetric techniques,” the disclosure of which is hereby incorporated by reference in its entirety for all purposes.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to detection and identification of explosives and more particularly to a thin-layer chromatography method for detection and identification of explosive compounds.

2. State of Technology

U.S. Pat. No. 6,096,205 for a hand portable thin-layer chromatography system provides the following state of the art information: “Various analytical techniques are used to measure the type and amount of contamination from unknown chemicals in environmental, industrial, civilian, and military situations. Conventional thin-layer chromatography (TLC) analysis is routinely used in analytical laboratories worldwide for quantitative and qualitative characterization of unknowns. This technique is ideal for rapid pre-screening and identification of known and unknown chemicals. TLC allows multiple samples and standards (in mg to ng quantities) to be chromatographed simultaneously on a TLC plate in a solvent tank. Semiquantitative and qualitative assessment from all samples is then readily obtained by inspection of the plates, which may be chemically developed and then illuminated to display the separated components (appearing as spots). Further quantitative analysis may be performed using an illumination box, camera, and data acquisition equipment. Unfortunately, conventional TLC apparatus is cumbersome, typically made of glass, and is not field-deployable or field-ruggedized for on-site analysis. Current TLC hardware is not hand portable when including all the necessary support equipment such as plates, tanks, solvent, pipettes, ruler, etc. Furthermore, the illumination and data acquisition equipment needed to fully analyze samples is oversized and extremely heavy. Thus, there is a need for a hand portable, field-ready TLC system, including data acquisition capability, that is cost-effective and efficient for analyzing multiple samples of unknown chemicals on-site in a variety of emergency and non-emergency situations.”

United States Published Patent Application No. 2005/0064601 for a system for analysis of explosives provides the following state of the art information: “A system for analysis of explosives. Samples are spotted on a thin layer chromatography plate. Multi-component explosives standards are spotted on the thin layer chromatography plate. The thin layer chromatography plate is dipped in a solvent mixture and chromatography is allowed to proceed. The thin layer chromatography plate is dipped in reagent 1. The thin layer chromatography plate is heated. The thin layer chromatography plate is dipped in reagent 2.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

In one embodiment, the present invention provides a thin-layer chromatography kit for identifying material present in a sample including a container containing a solvent; a swab, a pipette, a thin-layer chromatography plate, a developing chamber, and a ultra violet light source. In another embodiment, the present invention provides thin-layer chromatography method for identifying material present in a sample on a location including the steps of provide a thin-layer chromatography plate, wetting a swab is with a solvent providing a wetted swab, contacted the location of interest is with the wetted swab to obtain the sample providing a wetted swab with sample, placing the wetted swab with sample in the solvent to dissolve the sample and provide a solvent with sample, dipping a micropipette into the solvent with sample to obtain an amount of the solvent with sample, spotting the amount of the solvent with sample on the thin-layer chromatography plate, allowed the amount of the solvent with sample on the thin-layer chromatography plate to dry providing a thin-layer chromatography plate with sample, placing the a thin-layer chromatography plate with sample into a developing chamber with solvent mixture, allowing the thin-layer chromatography plate with sample to develop producing a developed thin-layer chromatography plate with sample, removing the developed thin-layer chromatography plate with sample from the developing chamber, and illuminating the developed thin-layer chromatography plate with sample with ultra violet light to produce an image for identifying the material present in the sample.

The kit of the present invention can be used for the detection and identification of common military explosives. The kit of the present invention can be used for the detection and identification of illegal drugs. The article, “QUALITATIVE ANALYSIS OF CONFISCATED ILLEGAL DRUGS BY THIN-LAYER CHROMATOGRAPHY,” FARMACIA, 2008, Vol. LVI, 5 541 describes the use of thin layer chromatography for detection of drugs. The article “QUALITATIVE ANALYSIS OF CONFISCATED ILLEGAL DRUGS BY THIN-LAYER CHROMATOGRAPHY,” FARMACIA, 2008, Vol. LVI, 5 541 is incorporated herein in its entirety by this reference. The kit of the present invention is useful to the military, law enforcement, first responders, and others.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 is a flow chart illustrating the steps taken in using one embodiment of the TLC (thin-layer chromatography) kit of the present invention.

FIG. 2 illustrates the items contained in the TLC kit.

FIG. 3A illustrates the basic TLC plate.

FIG. 3B illustrates a prepared TLC plate.

FIG. 4A illustrates a transparent developing chamber.

FIG. 4B illustrates a transparent developing chamber with TLC plate.

FIG. 5A illustrates a guide card.

FIG. 5B illustrates a guide card with TLC plate.

FIG. 5C illustrates another guide card for a TLC plate.

### DETAILED DESCRIPTION OF SPECIFIC EMBODIMENTS

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Thin-layer chromatography (TLC) is a simple, quick, and inexpensive procedure that can provide a rapid indication of the number of components in a mixture. TLC identifies a compound in a mixture when the position on the plate of a compound is compared with the position of a known compound, preferably both run on the same TLC plate.

A TLC plate is a sheet of glass, metal, or plastic which is coated with a thin layer of a solid adsorbent (usually silica or alumina). A small amount of the mixture to be analyzed is spotted near the bottom of this plate. The TLC plate is then placed in a shallow pool of a solvent in a developing chamber so that only the very bottom of the plate is contacted. This eluting liquid (solvent) is the mobile phase, and it slowly rises up the TLC plate by capillary action.

As the solvent moves past the spot that was applied, equilibrium is established for each component of the mixture proportioned between the solid absorbent and the solution. In principle, the components will differ in solubility and in the strength of their adsorption so some components will elute farther up the plate than others. When the solvent is near the top of the plate, the plate is removed from the developing chamber, dried, and the separated components of the mixture are visualized. If the compounds are colored, visualization is straightforward. Usually a UV lamp is used to visualize the plates. The ratio of the final position of the spot to the final height of the solvent front is the Rf value. This is a signature of a specific compound and is used to identify the compound.

The existing systems are large, heavy, and slow compared to the system of the present invention. For example the existing system weighs approximately 75 pounds, makes use of supplied electrical power, and requires up to two hours to complete testing for up to 10 unknown samples with initial and confirmatory testing protocols.

The system of the present invention has reduced size, requires far less space, is lighter in weight, provides the benefits of using gel-based solvent delivery, and is significantly more cost effective. The compact nature of the kit of the present invention renders it more useful to military, law enforcement, and other first responders. Standards of the system of the present invention can remain viable when pre-placed on TLC plate for at least 1 year, obviating the need for end user to prepare and apply standards in the field. A streamlined sampling and testing protocol was developed for the kit of the present invention that allows rapid, reproducible, separation and identification of the explosives. It involves pre-cutting and pre-spotting authentic explosive samples onto a 1″×2″ aluminum backed Cl8 TLC plate strip that could be user prepared or supplied in a commercial kit. The protocol requires swab sampling and application of the unknown onto the plate and developing the TLC plate with a “gelled solvent” mixture {takes around 2 minutes). The plate is dried and exposed to 254 non UV light. The nitroaromatic and nitramine explosives show up as dark spots on a colorless background. This procedure not only identifies all the explosives mentioned but it also allows the user to separate the suspected compounds by their explosive class, i.e. nitramines or nitroaromatics. In addition, since the transportation and storage of flammable liquids as commercial products is generally more difficult and requires more regulation than flammable solids or gels. Applicants have addressed this issue by employing a gelling agent that converts the liquid solvent system to a “gel” that is easy to use without the concern of spilling or orientation of the eluting system. We have demonstrated that treatment of the developing solvent with an inexpensive commercially available thixotropic gelling agent, yields a thick paste that may be dispensed using a spatula or spoon or through a squeezable tube similar to a toothpaste tube. The gelled solvent mixture gel, when used as the developing medium, yields comparable separation of the suspect explosive to that of the neat liquid. If desired, a different gelled elution solvent may also be used with this system. By using these two different elution systems, one can obtain confirmatory evidence of the identity of the suspect explosive.

The present invention provides a miniaturized field portable thin-layer chromatography (TLC) kit for the detection and identification of common military was developed. It is a portable set with components designed specifically designed for rapid identification of explosive compounds. The kit is useful to the military, law enforcement, first responders, and others. The kit of the present invention can also be used for the detection and identification of illegal drugs.

The kit uses aluminum backed reverse-phase C18 TLC plates (RP-18) to identify common military explosives (TNT, Tetryl, picric acid or Exp D, RDX, and F-IMX) all on one plate. The kit makes use of smaller pre-cut (−1″×2″) plates that are pre-spotted with explosives standards eliminating the need to apply these standards in the field. The kit is useful to law enforcement and others.

Applicants have demonstrated that these pre-spotted standards remain viable for greater than one year. By employing the smaller pre-spotted plates, the entire sampling, unknown spotting, developing, and identification process can be done in <3 minutes. The C18 TLC plate was found to be superior to the regular phase silica gel plates.

The present invention allows the first responders, law enforcement officials, and the military to assess whether a suspected item contains one these explosive ingredients. The reverse phase plates also have the advantage of being able to change the elution solvent and get a different separation pattern. This provides a method to confirm of the identity of a suspected explosive without changing the identity of the TLC plate. This is important when there may be a non-explosive material that has the same retention factor (Rr) as one of the standard explosive compounds. A second elution solvent allows confirmatory evidence that the suspected spot on the TLC plate is indeed the explosive in question.

The kit provides new methodology for the separation and identification of common military explosives (TNT, Tetryl, picric acid or Exp D, RDX, and HMX) using a single TLC plate. This new methodology employs reverse phase C18 TLC plates (RP-18) instead of the regular phase silica gel plates reported previously. The RP-18 TLC plates gives better separation of the various explosives tested than the normal phase silica plates and have the advantage of by changing the elution solvent a reversal of the retention times of the various explosives could be achieved using the same plate.

A streamlined sampling and testing protocol was developed for the new kit that allows rapid, reproducible, separation and identification of the explosives. It involves pre-cutting and pre-spotting authentic explosive samples onto a 1″×2″ aluminum backed C18 TLC plate that could be user prepared or supplied in a commercial kit. The protocol requires swab sampling and application of the unknown onto the plate and developing the TLC plate with a 16:1 toluene/isopropanol “gelled solvent” mixture (takes around 2 minutes). The plate is dried and exposed to 254 nm UV light. The nitroaromatic and nitramine explosives show up as dark spots on a colorless background. This procedure not only identifies all the explosives mentioned but it also allows the user to separate the suspected compounds by their explosive class, i.e. nitramines or nitroaromatics. Since the transportation and storage of flammable liquids as commercial products is generally more difficult and requires more regulation than flammable solids or gels. Applicants address this issue by employing a gelling agent that converts the liquid solvent system to a “gel” that allows for ease of use without the concern of spilling or orientation of the eluting system. We have demonstrated that treatment of the developing solvent with Cab-O-Sil, an inexpensive commercially available thixotropic gelling agent, yields a thick paste that may be dispensed using a spatula or spoon or through a squeezable tube similar to a toothpaste. A 6.5% Cab-O-Sil/16:1 toleune/isopropanol mixture gel, when used as the developing medium, yields adequate separation of the suspect explosive to that of the neat liquid. The Cab-O-Sil gels were stable for weeks if stored in a tightly closed container. If desired, a different gelled elution solvent may also be used with this system. By using these two elution systems, 16:1 toluene/isopropanol and a 11:9:2 water/MeOH/acetonitrile gel, one can obtain confirmatory evidence of the identity of the suspect explosive.

The procedures for the separation of the standard military explosives is described below:

For standard explosives: Pre-Spotted TNT, Picric Acid, Explosive D, Tetryl, HMX, and RDX.

For narcotics: Pre-Spotted Heroin, Morphine, Codeine, Demerol, Fentanyl, Hydrocodone, Hydromorphone, Methadone, Opium, Oxycodone, Percocet, Vicodin, and Phenobarbital.

Materials:

TLCplates: Machery-Nagel RP-18W UV254, aluminum sheet (reverse phase (RP) plates): cut and pre-spotted with standards

Developing gel: 6.5% Cab-O-Sil/16:1 toleune/isopropanol mixture

Cotton swabs

Sample collection/dilution vial

Battery powered fan (optional)

Battery powered 254 nm UV lamp (required) Developing Tank

1-5 microliter disposable pipette

Method:

The explosive standards are currently placed in two lanes on the outer portion of the TLC plate by spotting with a solution at a concentration of 250 ng/iL in acetonitrile. Standard 1 (lane 1) contains the following explosives: TNT, RDX, and Picric Acid. Standard 2 (lane 2) contains Tetryl, HMX, and Explosive D. The center lane is marked with a circle to guide the user to apply the unknown at the appropriate location.

To prepare for analysis, the cotton swab is “wetted” with solvent from the vial (e.g. acetone (nail polish remover) or acetonitrile) and the object or location of interest is contacted with the swab. If desired, more environmentally friendly solvents such as ethanol or isopropanol (rubbing alcohol) can also be used. The swab is replaced into the solvent vial to dissolve the sampled material. A disposable micropipette is dipped into the solvent vial and “spotted” on the marked center lane of the TLC plate and is allowed to dry (<30 seconds). The plate is then placed into a clear or translucent plastic developing chamber to which the gelled solvent mixture has been previously applied. [Depending on how well the plastic chamber seals dictates how long in advance that can be]. The RP plate is allowed to develop for 2 min (Toluene:Isopropanol (16:1) eluent) either using a timer (optional) or by visually observing the solvent front and removing when the front is approximately ¼″ from the top of the plate. Remove the plate and allow solvent to evaporate. It takes approximately 30 seconds using the portable fan (optional) for complete evaporation. Place the developed plate in the marked registration guide card (supplied) and illuminate with the portable UV lamp (254 nm). The use of this card obviates the need to measure Rf (retention factor) values. If the solvent has not completely evaporated, the plate will appear dark; however, once the solvent has evaporated the plate is nearly colorless under UV light. At this point, 6 (TNT, Tetryl, picric acid or Exp D, RDX, and HMX) of the explosives are identifiable due to their UV absorption. If desired, while irradiating the plate with UV light, photograph the explosives that are observed. The original sample vial can be capped and returned to another location for alternative forensic analytical tests.

The new rapid TLC approach will be readily amenable to the detection and identification of various inorganic oxidizers used in commonly reported fuel/oxidizer explosives (e.g. nitrate, nitrite, perchlorate, chlorate and bromate) by suitable modifications. It is also anticipated that additional modifications would allow for the detection of the nitrate esters (e.g. PETN and nitroglycerine) as well as for urea and urea nitrate.

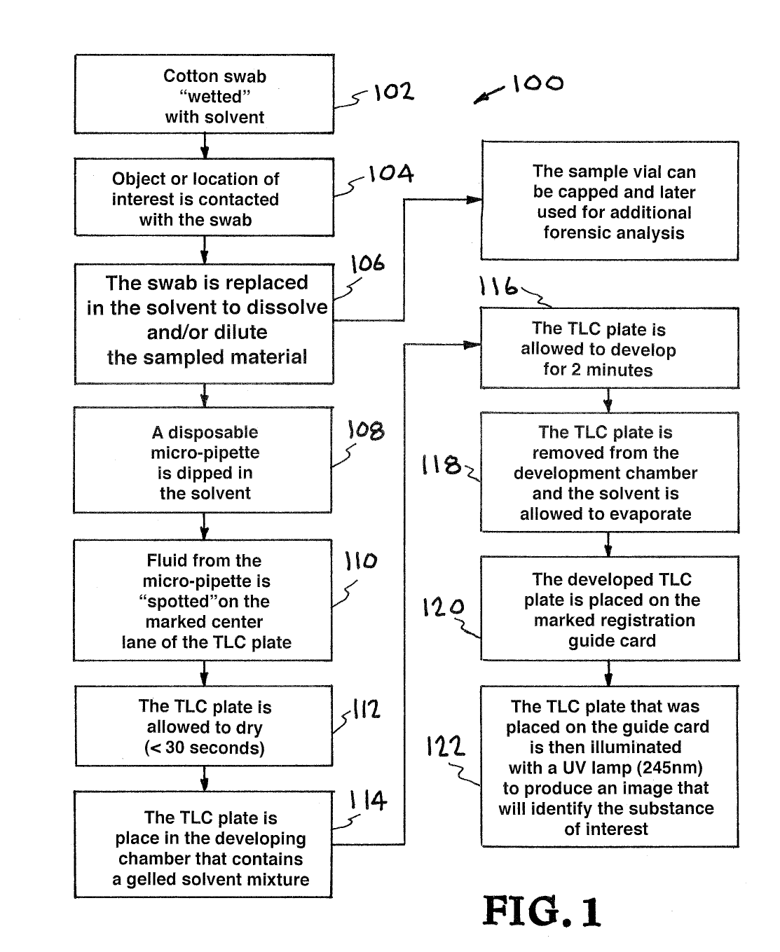

Referring now to the drawings and in particular to FIG. 1 a flow chart illustrates the steps taken in using one embodiment of the TLC (thin-layer chromatography) kit of the present invention. The FIG. 1 flow chart is designated generally by the reference numeral 100. The flow chart 100 is a visual image that will help with the description of the steps taken in using the TLC kit to identify a substance of interest. In the first step 102 a swab is wetted with a solvent. Examples of solvents are acetone and acetonitrile or if it is desired to use more environmentally friendly solvents such as ethanol or isopropanol, these can also be used. In step two 104 the object or location of interest is contacted with the swab. In step three 106 the swab is replace in the solvent to dissolve the sampled material. In step four 108 a disposable micropipette is dipped into the solvent. In step five 110 fluid from the micropipette is spotted on the marked center lane of the TLC plate. In step six 112 the TLC plate is allowed to dry (<30 seconds). In step seven 114 the TLC plate is then placed into a clear or translucent developing chamber to which a gelled solvent mixture has been previously applied. In step eight 116 the TLC plate is allowed to develop for two minutes either using a timer (optional) or by visually observing the solvent front. In step nine 118 after the two minutes has passed or the gel front is approximately one quarter inch from the top of the TLC plate the plate is removed from the developing chamber and the solvent is allowed to evaporate. In step ten 120 the developed TLC plate is placed on the marked registration guide card. In the final step, step eleven 122 the TLC that was placed on the guide card is then illuminated with UV (245 nm) to produce an image that will identify the substance of interest. The original sample vial (step three 106) can be capped and later used for additional forensic analysis.

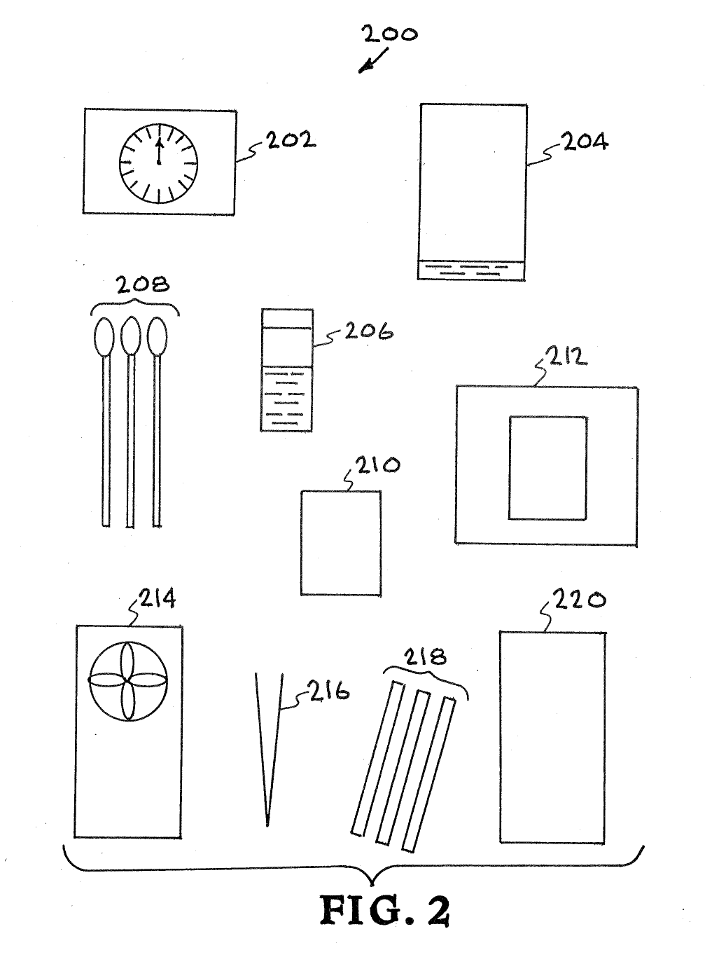

FIG. 2 shows the items contained in a TLC kit 200. These item are identified by the following numbered list with a description of each item.

1. Item 202 is a timer (optional), any off the shelf inexpensive timer (optional) will work.

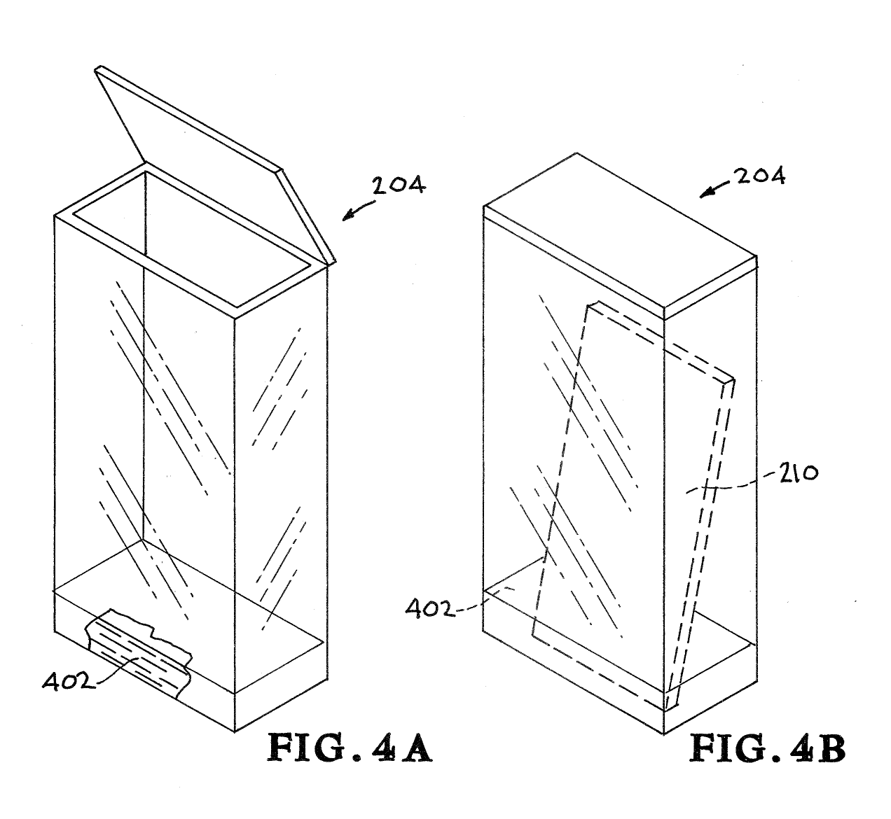

2. Item 204 is the developing chamber which can be any transparent or translucent container of an appropriate size. (FIG. 4A and FIG. 4B)

3. Item 206 is a small vial with cap to contain the solvent that starts the process. Solvents choices were described in the description of the FIG. 1 flow chart.

4. Item 208 is cotton tipped swab.

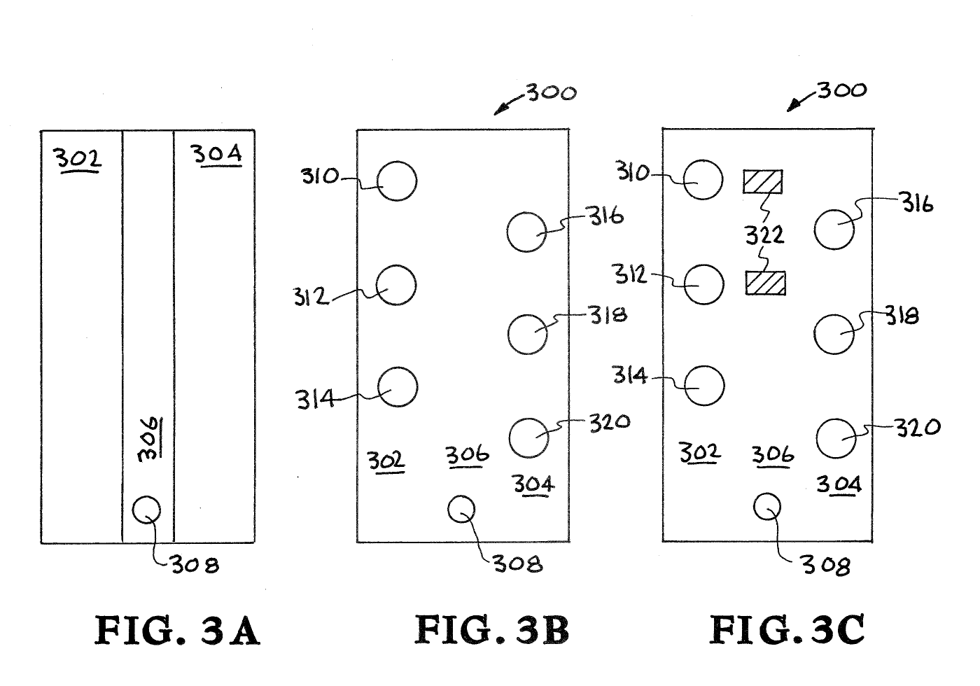

5. Item 210 is the TLC plate. (FIGS. 3A, 3B, and 3C)

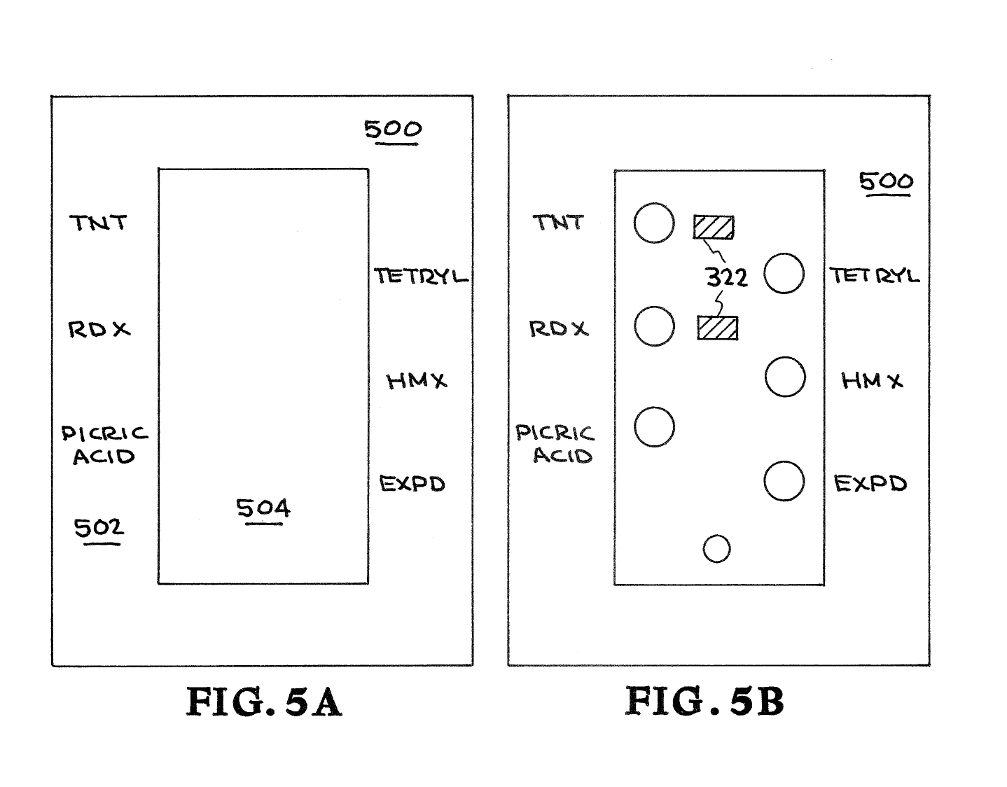

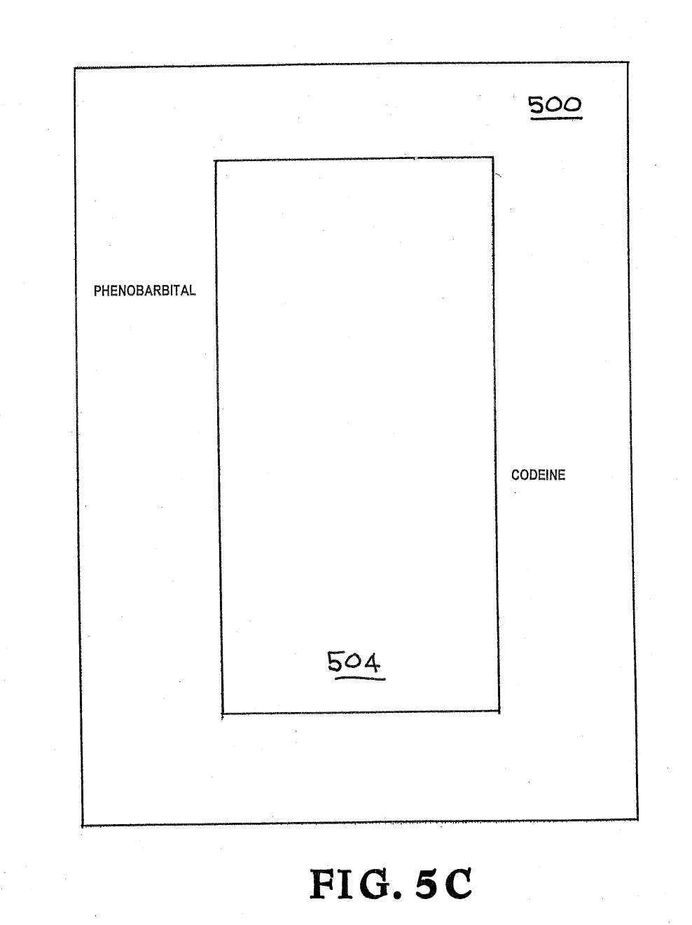

6. Item 212 is the guide card. (FIGS. 5A and 5B)

7. Item 214 is an inexpensive battery powered fan (optional).

8. Item 216 is a pair of tweezers (optional).

9. Item 218 are disposable micropipettes.

10. Item 220 is a portable battery powered UV light source.

FIG. 3A is a drawing showing a TLC plate 300. The plate 300 is divided into three lanes. There are two outside lanes 302 and 304 and a center lane 306. An application spot 308 is positioned on the center lane 306. The spot 308 is where the fluid in the micropipette is deposited on the TLC plate as described in step five (110) in connection with the FIG. 1 flow chart.

FIG. 3B shows a prepared TLC plate that has been pre-spotted with explosives standards eliminating the need to apply standards in the field. It has been demonstrated that these pre-spotted standards remain viable for greater than one year. While the example TLC plate shown here is spotted for explosives TLC plates may be prepared with a great variety of substances that are to be identified. In another embodiment the TLC plate has been pre-spotted with narcotics standards eliminating the need to apply standards in the field. The pre-Spotted narcotics standards include Heroin, Morphine, Codeine, Demerol, Fentanyl, Hydrocodone, Hydromorphone, Methadone, Opium, Oxycodone, Percocet, Vicodin, and Phenobarbital.

FIG. 3C is an illustration of a developed TLC plate. As shown the gel has traveled up the TLC plate and when exposed to the UV light source both TNT and RDX are shown to have been contained in the sample under test.

FIG. 4A is a drawing showing the translucent or transparent developing chamber 204 (FIG. 2) that contains previously applied gelled solvent mixture (Toluene:Isopropanol (16:1) eluent) 402.

FIG. 4B shows that the TLC plate has been inserted into the developing chamber 204 and the lid of the chamber is closed so developing of the TLC plate may proceed. As described in step 8 (116) of the FIG. 1 flow chart development of the TLC plate takes about two minutes and either using the timer (optional) item 202 (FIG. 2) or by visually observing the solvent front as it moves up the TLC plate and removing the TLC plate after the gel mixture front is approximately ¼ inch from the top of the plate.

FIG. 5A illustrates a guide card 500. The guide card 500 has a perimeter area 502 for printing information pertinent to the substances being tested for and an area in the center for placing a developed TLC plate. Continuing with explosives identification as the example used in this application shown is a guide card with the names of various explosives such as TNT, RDX, Picric Acid, Tetryl, Hmx and Expd. The guide card is necessary as this information is not on the prepared TLC plate.

FIG. 5B shows the guide card 500 with a developed TLC plate such as the one illustrated in FIG. 3C in place at the location 504 provided. The guide card and TLC plate combination is now ready to be viewed under the UV light source where the identification marks 322 will be visible.

FIG. 5C shows an alternative guide card 500. The guide card 500 has a central area 504 on which a developed TLC plate such as the one illustrated in FIG. 3C can be positioned.

The alternative guide card 500 can be used with a TLC plate that identifies Codeine and Phenobarbital. The alternative guide card 500 includes the words and positions on the card for Codeine and Phenobarbital. Codeine is shown low on the plate and Phenobarbital is shown high on the plate. The guide card and TLC plate combination can be viewed under the UV light source where the identification marks for Codeine and Phenobarbital will be visible.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A thin-layer chromatography kit for identifying material present in a sample, comprising:
a container containing a solvent;
a swab,
a pipette,
a thin-layer chromatography plate,
a developing chamber, and
a ultra violet light source.

2. The thin-layer chromatography kit of claim 1 wherein said developing chamber is a transparent or translucent developing chamber.

3. The thin-layer chromatography kit of claim 1 wherein said ultra violet light source is a portable battery powered ultra violet light source.

4. The thin-layer chromatography kit of claim 1 wherein said thin-layer chromatography plate is a thin-layer chromatography plate with two outside standard lanes and a center sample lane.

5. The thin-layer chromatography kit of claim 1 wherein said thin-layer chromatography plate is a thin-layer chromatography plate with at least one pre-spotted standard lane and at least one sample lane.

6. The thin-layer chromatography kit of claim 5 wherein said one pre-spotted standard lane contains a pre-spotted standard for explosives.

7. The thin-layer chromatography kit of claim 5 wherein said one pre-spotted standard lane contains a pre-spotted standard for TNT or Tetryl or picric acid or Exp D or RDX or F-IMX explosives.

8. The thin-layer chromatography kit of claim 5 wherein said one pre-spotted standard lane contains a pre-spotted standard for narcotics.

9. The thin-layer chromatography kit of claim 5 wherein said one pre-spotted standard lane contains a pre-spotted standard for Heroin or Morphine or Codeine or Demerol or Fentanyl or Hydrocodone or Hydromorphone or Methadone or Opium or Oxycodone or Percocet or Vicodin narcotics.

10. The thin-layer chromatography kit of claim 1 including a guide card adapted to be positioned over said thin-layer chromatography plate.

11. The thin-layer chromatography kit of claim 1 including a battery powered fan.

12. The thin-layer chromatography kit of claim 1 including a timer.

13. The thin-layer chromatography kit of claim 1 including a pair of tweezers.

14. The thin-layer chromatography kit of claim 1 wherein said container containing a solvent includes a cap.

15. A thin-layer chromatography plate for identify material present in a sample, comprising:
a thin-layer chromatography plate,
a pre-spotted standard lane on said thin-layer chromatography plate,
a pre-spotted standard in said pre-spotted standard lane,
a sample lane on said thin-layer chromatography plate, and
a location for the sample in said sample lane.

16. The thin-layer chromatography plate of claim 14 wherein said pre-spotted standard is a said pre-spotted standard for explosives.

17. The thin-layer chromatography plate of claim 14 wherein said pre-spotted standard is a said pre-spotted standard for narcotics.

18. The thin-layer chromatography plate of claim 14 including a guide card adapted to be positioned over said thin-layer chromatography plate.

19. The thin-layer chromatography plate of claim 14 wherein said guide card adapted to be positioned over said thin-layer chromatography plate includes a guide for explosives.

20. The thin-layer chromatography plate of claim 14 wherein said guide card adapted to be positioned over said thin-layer chromatography plate includes a guide for narcotics.

21. A thin-layer chromatography method for identifying material present in a sample on a location, comprising the steps of:
providing a thin-layer chromatography plate,
wetting a swab is with a solvent providing a wetted swab,
contacting said location with said wetted swab to obtain the sample providing a wetted swab with sample,
placing said wetted swab with sample in said solvent to dissolve the sample and provide a solvent with sample,
dipping a micropipette into said solvent with sample to obtain an amount of said solvent with sample,
spotting said amount of said solvent with sample on said thin-layer chromatography plate,
allowing said amount of said solvent with sample on said thin-layer chromatography plate to dry providing a thin-layer chromatography plate with sample,
placing said a thin-layer chromatography plate with sample into a developing chamber with solvent mixture,
allowing said thin-layer chromatography plate with sample to develop producing a developed thin-layer chromatography plate with sample,
removing said developed thin-layer chromatography plate with sample from said developing chamber, and
illuminating said developed thin-layer chromatography plate with sample with ultra violet light to produce an image for identifying the material present in the sample.

22. The thin-layer chromatography method of claim 20 including the step of placing a marked registration guide card on said developed thin-layer chromatography plate with sample.

23. The thin-layer chromatography method of claim 21 wherein said step of illuminating said developed thin-layer chromatography plate with sample with ultra violet light to produce an image for identifying the material present in the sample includes matching said sample on said developed thin-layer chromatography plate with sample with said marked registration guide card.

24. A method of using a thin-layer chromatography kit for identifying material present in a sample from a location wherein the kit includes a container containing a solvent, a swab, a pipette, a thin-layer chromatography plate, a developing chamber with solvent mixture, and an ultra violet light source, comprising the steps of:
wetting the swab is with solvent from the container providing a wetted swab,
contacting said location with said wetted swab to obtain the sample providing a wetted swab with sample,
placing said wetted swab with sample in the solvent to dissolve the sample and provide a solvent with sample,
dipping a micropipette into said solvent with sample to obtain an amount of said solvent with sample,
spotting said amount of said solvent with sample on the thin-layer chromatography plate,
allowing said amount of said solvent with sample on the thin-layer chromatography plate to dry providing a thin-layer chromatography plate with sample,
placing said thin-layer chromatography plate with sample into the developing chamber with solvent mixture,
allowing the thin-layer chromatography plate with sample to develop producing a developed thin-layer chromatography plate with sample,
removing said developed thin-layer chromatography plate with sample from said developing chamber, and
illuminating said developed thin-layer chromatography plate with sample with the ultra violet light to produce an image for identifying the material present in the sample.

25. The thin-layer chromatography method of claim 23 including the step of placing a marked registration guide card on said developed thin-layer chromatography plate with sample.
